(19) United States
(12) Patent Application Publication
(10) Pub. No.: US 2023/0244608 A1
(43) Pub. Date: Aug. 3, 2023

(54) COMPUTER-READABLE RECORDING MEDIUM HAVING STORED THEREIN CROSS VALIDATION PROGRAM, METHOD FOR CROSS VALIDATION, AND INFORMATION PROCESSING APPARATUS

(71) Applicant: Fujitsu Limited, Kawasaki-shi (JP)

(72) Inventor: Satoshi Imamura, Kawasaki (JP)

(73) Assignee: Fujitsu Limited, Kawasaki-shi (JP)

(21) Appl. No.: 17/959,344

(22) Filed: Oct. 4, 2022

(30) Foreign Application Priority Data
Jan. 28, 2022 (JP) 2022011684

(51) Int. Cl. G06F 12/0868; G06F 13/16

(52) U.S. Cl. CPC G06F 12/0868; G06F 13/1673

(57) ABSTRACT

A computer-readable recording medium having stored therein a program for causing a computer to execute a process including: calculating, based on first information indicating an access pattern of a plurality of subsets in step of a cross validation process of a machine learning model and indicating two or more of the subsets used in each step, a count that each subset is consecutively used over steps among steps in each pattern for execution orders of the steps; determining an order of the steps of the cross validation process from the orders of candidate patterns, the determined order having a largest total of the counts of the subsets; and arranging a given number of subsets having largest counts from a top over steps in the determined order into a second memory having an accessing speed higher than an accessing speed of a first memory, the first memory storing the subsets.

### CROSS-REFERENCE TO RELATED APPLICATION

This application is based upon and claims the benefit of priority of the prior Japanese Patent application No. 2022-011684, filed on Jan. 28, 2022, the entire contents of which are incorporated herein by reference.

### FIELD

The embodiment discussed herein is directed to a computer-readable recording medium having stored therein a cross validation program, a method for cross validation, and an information processing apparatus.

### BACKGROUND

Cross Validation of a machine learning model is a scheme that divides an entire data set into multiple subsets and repeats training of the machine learning model and evaluating of the accuracy, using multiple combinations of training subsets and validation subsets selected from the multiple subsets.

One of the schemes of the cross validation is shuffle-split cross-validation that, in iteration of the training and the accuracy evaluating (the iteration may be referred to as “split” or “step”), randomly limits subsets to be selected for the combinations to some of all the subsets. In other words, in the cross validation such as the shuffle-split cross-validation, an unused subset is present in each split and the respective usage counts of all the subsets in the entire cross validation are different from one another.

As a memory system of a computer (information processing apparatus), a hierarchical memory system has been known. In a hierarchical memory system, a processor such as a Central Processing Unit (CPU) can access both of a small-volume high-speed memory (e.g., Dynamic Random Access Memory (DRAM)) and a large-volume low-speed memory (e.g., Non-Volatile Dual In-line Memory Module (NVIMM) or Solid State Drive (SSD)).

A hierarchical memory system sometimes uses a data arranging technique that uses the high-speed memory as a cache of the low-speed memory because of the limited capacity of the high-speed memory. For example, the Operating System (OS) or hardware (HW) of a computer performs cache control by the Least-Recently Used (LRU) algorithm. This cache control is a method of speeding up repeated access to the same data by caching the most recent accessed data to the high-speed memory and evicting the least-recently accessed (i.e. LRU) data to the low-speed memory.

[Patent Document 1] Japanese Laid-open Patent Publication No. 2021-43593

Here, it is assumed that a computer that executes the above-described cross validation employs a hierarchical memory system. As a premise, the capacity of the high-speed memory is less than the total data size of all the subsets, which means the high-speed memory does not afford to store all the subsets.

In each iteration of the cross validation, accesses are sequentially made to multiple training subsets and one or more validating subset. Therefore, a subset cached in the high-speed memory in a certain iteration (split) may be evicted to the low-speed memory prior to being accessed again in the process of a subsequent iteration (split).

As the above, despite the computer including the high-speed memory, an access to the low-speed memory is generated (e.g., frequently) during the cross validation, so that the performance may be restricted due to, for example, lowering the processing rate of the processor and consequent increasing the processing times of the cross validation.

### SUMMARY

According to an aspect of the embodiments, a non-transitory computer-readable recording medium having stored therein a cross validation program for causing a computer to execute a process includes: calculating, based on first information indicating an access pattern of a plurality of subsets in each of a plurality of steps of a cross validation process of a machine learning model and indicating two or more of the plurality of subsets used in each of the plurality of steps, a consecutive usage count that each of the plurality of subsets is consecutively used over steps among the plurality of steps in each of a plurality of candidate patterns for execution orders of the plurality of steps; determining an execution order of the plurality of steps of the cross validation process from the execution orders of the plurality of candidate patterns, the determined execution order having a largest total of the consecutive usage counts of the plurality of subsets; and arranging a given number of subsets having largest consecutive usage counts from a top over steps in the determined execution order into a second memory having an accessing speed higher than an accessing speed of a first memory, the first memory storing the plurality of subsets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the hardware (HW) configuration of a computer that achieves the function of a cross validation apparatus according to one embodiment;

FIG. 2 is a block diagram illustrating an example of a hierarchical memory system according to the one embodiment;

FIG. 3 is a block diagram schematically illustrating an example of a software configuration of the cross validation apparatus of the one embodiment;

FIG. 4 is a diagram illustrating an example of a cross validating process using multiple subsets;

FIG. 5 is a diagram illustrating an example of a subset usage list;

FIG. 6 is a diagram illustrating an example of a consecutive usage counts and obtaining of subset IDs for each execution order;

FIG. 7 is a diagram illustrating an example of an initial arrangement ID list and a split execution order list;

FIG. 8 is a diagram illustrating an example of a determining process of a swapping timing;

FIG. 9 is a diagram illustrating an example of obtaining a swapping ID list;

FIG. 10 is a diagram illustrating an example of a subset arranging process;

FIG. 11 is a flow diagram illustrating an example of operation of a determining process of a subset arrangement policy performed by the cross validation apparatus according to one embodiment;

FIG. 12 is a flow diagram illustrating an example of an arranging process of a subset performed by the cross validation apparatus according to one embodiment; and

FIG. 13 is a diagram illustrating an example of a cross validating process according to a comparative example.

### DESCRIPTION OF EMBODIMENT(S)

Hereinafter, an embodiment of the present invention will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. In the drawings to be used in the following description, the same reference numbers denote the same or similar parts, unless otherwise specified.

### (A) Example of Configuration

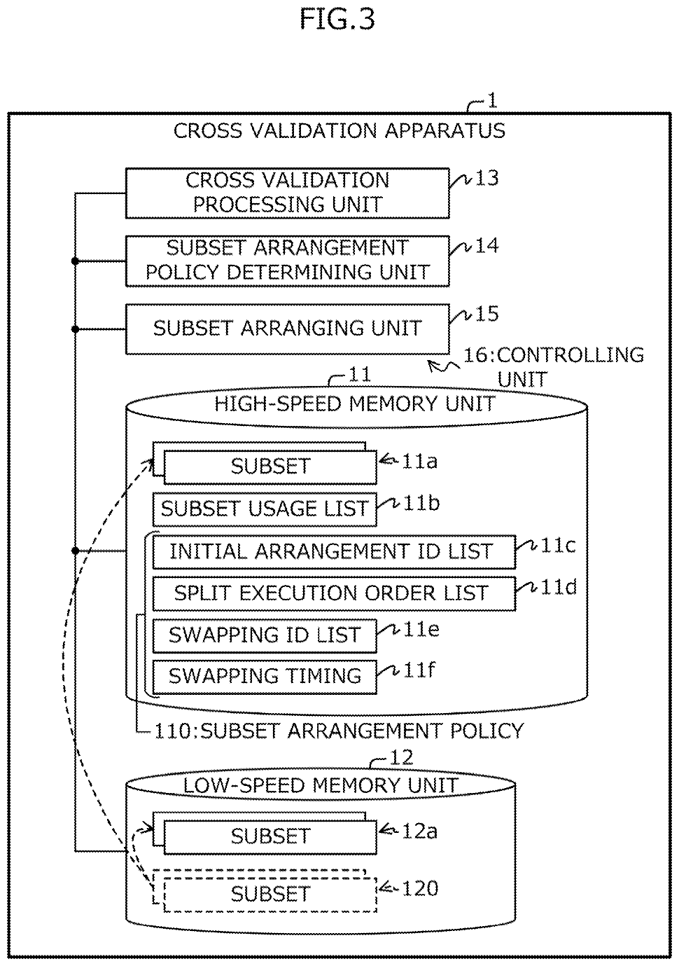

Hereinafter, description will now be made in relation to a cross validation apparatus 1 (see FIG. 3) according to one embodiment.

### (A-1) Example of Hardware Configuration

The cross validation apparatus 1 according to the embodiment may be a virtual server (Virtual Machine (VM)) or a physical server. The functions of the data correction apparatus 1 may be achieved by one computer or by two or more computers. Further, at least some of the functions of the cross validation apparatus 1 may be implemented using Hardware (HW) resources and Network (NW) resources provided by cloud environment.

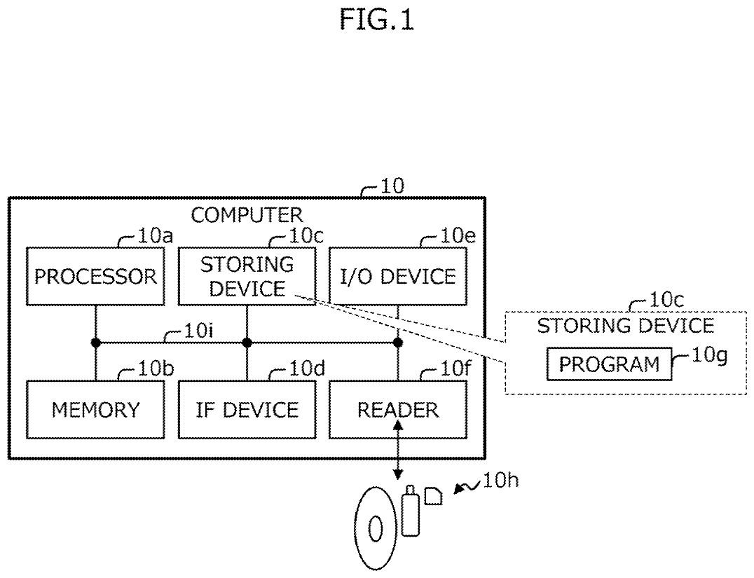

FIG. 1 is a block diagram illustrating an example of the hardware (HW) configuration of a computer 10 that achieves the functions of the cross validation apparatus 1. If multiple computers are used as the HW resources for achieving the functions of the cross validation apparatus 1, each of the computers may include the HW configuration illustrated in FIG. 1.

As illustrated in FIG. 1, the computer 10 may illustratively include a HW configuration formed of a processor 10a, a memory 10b, a storing device 10c, an IF (Interface) device 10d, an I/O (Input/Output) device 10e, and a reader 10f.

The processor 10a is an example of an arithmetic operation processing device that performs various controls and calculations. The processor 10a may be communicably connected to the blocks in the computer 10 via a bus 10i. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Graphics Processing Units (GPUs), Accelerated Processing Units (APUs), Digital Signal Processors (DSPs), Application Specific ICs (ASICs) and Field Programmable Gate Arrays (FPGAs), or combinations of two or more of these ICs.

For example, the processor 10a may be a combination of a processing device such as a CPU that executes various controls of cross validation and an accelerator that executes the machine learning process in the cross validation. Examples of the accelerator include the GPUs, APUs, DSPs, ASICs, and FPGAs described above.

The memory 10b is an example of a HW device that stores various types of data and information such as a program. Examples of the memory 10b include one or both of a volatile memory such as a Dynamic Random Access Memory (DRAM) and a non-volatile memory such as an NVDIMM or a Persistent Memory (PM).

The storing device 10c is an example of a HW device that stores various types of data and information such as program. Examples of the storing device 10c include a magnetic disk device such as a Hard Disk Drive (HDD), a semiconductor drive device such as a Solid State Drive (SSD), and various storing devices such as a nonvolatile memory. Examples of the nonvolatile memory include a flash memory, a Storage Class Memory (SCM), and a Read Only Memory (ROM).

The storing device 10c may store a program 10g (cross validation program) that implements all or part of various functions of the computer 10. For example, the processor 10a can achieve the functions of the cross validation apparatus 1 (for example, the controlling unit 16) to be detailed below by expanding the program 10g stored in the storing device 10c onto the memory 10b and executing the expanded program 10g.

The IF device 10d is an example of a communication IF that controls connection and communication of one or the both of a network. For example, the IF device 10d may include an applying adapter conforming to Local Area Network (LAN) such as Ethernet (registered trademark) or optical communication such as Fibre Channel (FC). The applying adapter may be compatible with one of or both wireless and wired communication schemes. For example, the cross validation apparatus 1 may be communicably connected, through the IF device 10d and a non-illustrated network, to another apparatus, such as an apparatus that provides a data set to the cross validation apparatus 1 or an apparatus that receives a processing result of cross validation from the cross validation apparatus 1. Furthermore, the program 10g may be downloaded from the network to the computer through the communication IF and be stored in the storing device 10c, for example.

The I/O device 10e may include one or both of an input device and an output device. Examples of the input device include a keyboard, a mouse, and a touch panel. Examples of the output device include a monitor, a projector, and a printer.

The reader 10f is an example of a reader that reads data and programs recorded on a recording medium 10h. The reader 10f may include a connecting terminal or device to which the recording medium 10h can be connected or inserted. Examples of the reader 10f include an applying adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

The recording medium 10h is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus. For example, at least one of the I/O device 10e and the reader 10f may be omitted.

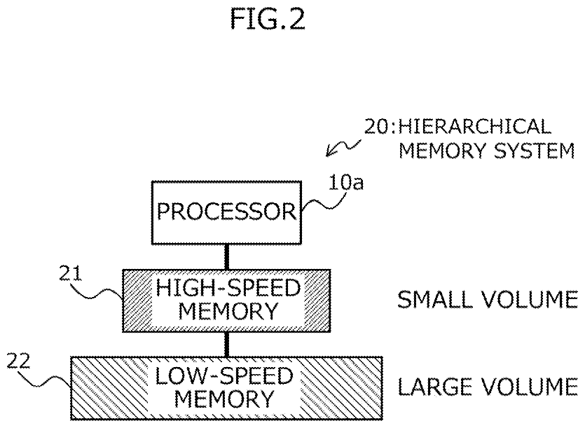

FIG. 2 is a block diagram schematically illustrating an example of a hierarchical memory system 20 according to the one embodiment. The computer 10 may adopt a hierarchical memory system 20, which may illustratively include a processor 10a, a high-speed memory 21, and a low-speed memory 22. The processor 10a is capable of accessing the both of the high-speed memory 21 and the low-speed memory 22.

The high-speed memory 21 is an example of a memory higher in speed and smaller in capacity than the low-speed memory 22, and is exemplified by a volatile memory such as a DRAM. The high-speed memory 21 may be achieved by, for example, the memory 10b (volatile memory).

The low-speed memory 22 is an example of a memory lower in speed and larger in capacity than the high-speed memory 21, and is exemplified by a non-volatile memory such as an NVDIMM or a PM or storage such as an SSD. The low-speed memory 22 may be achieved by, for example, the memory 10b (non-volatile memory) or the storing device 10c.

The combination of the high-speed memory 21 and the low-speed memory 22 is not limited to a combination of a volatile memory with a non-volatile memory or a storage, and alternatively may be a combination that satisfies an access rate of “the high-speed memory 21>the low-speed memory 22” and a capacity of “the high-speed memory 21<the low-speed memory 22”.

In the hierarchical memory system 20, data arrangement control between the high-speed memory 21 and the low-speed memory 22 is performed by the HW or the OS executed by the processor 10a. The data arrangement control includes cache control by the LRU algorithm.

For example, when the high-speed memory 21 is a DRAM and the low-speed memory 22 is an SSD, cache control by the LRU algorithm is accomplished by the swapping function of the OS. Further, when the high-speed memory 21 is a DRAM and the low-speed memory 22 is an NVDIMM, cache control by the LRU algorithm is accomplished by cache control by the HW.

### (A-2) Example of Software Configuration

FIG. 3 is a block diagram schematically illustrating an example of a software configuration of the cross validation apparatus 1 of the one embodiment. The cross validation apparatus 1 is an example of an information processing apparatus and executes a cross validating process on a machine learning model, using multiple data sets obtained by dividing a data set.

As illustrated in FIG. 3, the cross validation apparatus 1 may illustratively include, as a software (functional) configuration, a high-speed memory unit 11, a low-speed memory unit 12, a cross validation processing unit 13, a subset arrangement policy determining unit 14, and a subset arranging unit 15.

Each of the high-speed memory unit 11 and the low-speed memory unit 12 is an example of a storing region and stores various data used by the cross validation apparatus 1. The high-speed memory unit 11 is an example of a second memory that is capable of access faster than the low-speed memory unit 12, and may be implemented by, for example, a storing region included in the high-speed memory 21 illustrated in FIG. 2. The low-speed memory unit 12 is an example of a first memory that stores multiple subsets 120, and may be implemented by, for example, a storing region included in the low-speed memory 22 illustrated in FIG. 2.

As illustrated in FIG. 3, the high-speed memory unit 11 may illustratively be capable of storing multiple subsets 11a, a subset usage list 11b, an initial arrangement ID list 11c, a split execution order list 11d, a swapping ID list 11e, and a swapping timing 11f. The low-speed memory unit 12 may illustratively be capable of storing multiple subsets 12a. In the following explanation, the lists 11b to 11e are each represented in table formats, but the present invention is not limited thereto. The lists 11b to 11e may alternatively be in various formats such as a Database (DB) or an array.

The cross validation processing unit 13 executes a cross validation process of a machine learning model by using a cross verification library (function). The cross validation processing unit 13 divides a data set into multiple subsets 120, for example.

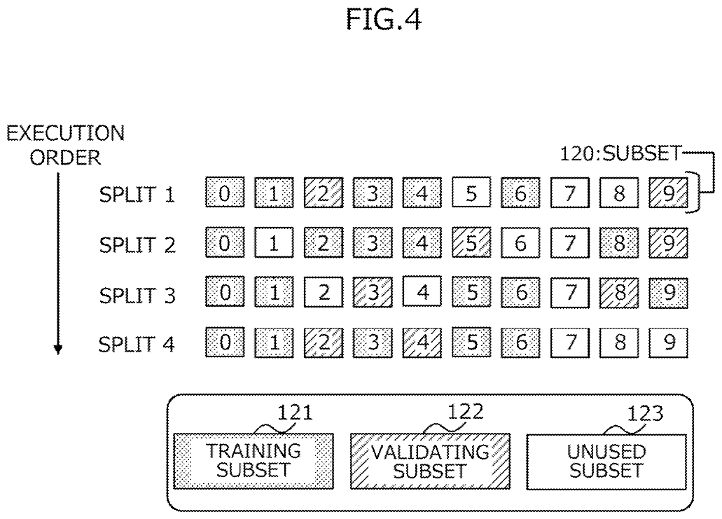

FIG. 4 is a diagram illustrating an example of a cross validating process using multiple subsets 120. In the example of FIG. 4, the data set is divided into ten subsets 120 provided one with each of subset IDs (Identifiers) 0 to 9.

In addition, in FIG. 4, it is assumed that five training subset 121 (see shaded subsets) and two validating subset 122 (see hatched subsets) among ten subsets 120 are used in each of four iterations (denoted as “split 1” to “split 4” in execution order). In other words, in each of the four iterations, three unused subsets 123 (see white subsets) among the ten subsets 120 are assumed not to be used. The number (split number) of the subsets 120 and the number of training subsets 121, the number of validating subsets 122, and the number of unused subsets 123 are not limited to the numbers illustrated in FIG. 4.

The cross validation processing unit 13 repeats a process of training a machine learning model using the five training subsets 121 in the cross validation process and obtaining of an inference result by inputting two validating subsets 122 into the trained machine learning model in the execution order (four iterations in the example of FIG. 4). Then, the cross validation processing unit 13 evaluates the accuracy based on inference results obtained by the respective iterations.

In the cross validation process illustrated in FIG. 4, the cross validation apparatus 1 according to the one embodiment preferentially arranges a subset 120 having a large usage count in the high-speed memory 21. As a result, the cross validation apparatus 1 increases the access number to the high-speed memory 21, i.e., reduces the access number to the low-speed memory 22, thereby achieving a faster cross validation process.

For this purpose, the cross validation processing unit 13 instructs the subset arrangement policy determining unit 14 to perform a determining process of the subset arrangement policy 110. For example, upon receipt of a processing request for a cross validation processing via a non-illustrated network or the like, the cross validation processing unit 13 instructs the subset arrangement policy determining unit 14 to execute the determining processing of the subset arrangement policy 110 in response to the processing request. The processing request may include a data set to be used in the cross validation process.

The cross validation processing unit 13 may, for example, generate a subset usage list 11b to be used in the cross validation and store the list 11b in the high-speed memory unit 11. The cross validation processing unit 13 may store multiple subsets 120 obtained by dividing the data set included in the process request in the low-speed memory unit 12.

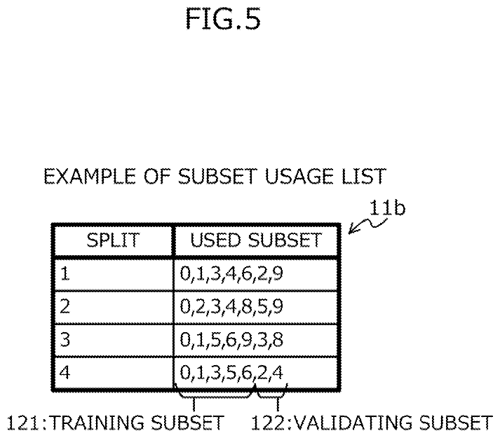

FIG. 5 is a diagram illustrating an example of a subset usage list 11b. The subset usage list 11b exhibits combinations of training subsets 121 and validating subsets 122 used in each iteration (each split) illustrated in FIG. 4. In other words, the subset usage list 11b is an example of first information indicating an access pattern of the multiple subsets 120 used in each split (each step) of the a cross validation process and indicating two or more of the multiple subsets 120 used in each split (each step).

As illustrated in FIG. 5, the subset usage list 11b may include items of “split” and “used subset”. The “split” is identification information (for example, split IDs) of splits (iterations, steps) in a cross validation process. The “used subset” is identification information (for example, subset ID) of each of the multiple subsets 120 used in each split. The “use” of a subset 120 may mean to use the subset 120 in a cross validation process as a training subset 121 or a validating subset 122.

Here, in the cross validation process, the validating subsets 122 are used after the training subsets 121 are used. In addition, in each of the training subsets 121 and the validating subsets 122, the subsets 120 are used in a predetermined usage order, for example, in an ascending order of the subset IDs. Furthermore, the number of training subsets 121 and the number of validating subsets 122 are fixed.

In the one embodiment, on the basis of these assumptions, subset IDs are set in the order of usage (see FIG. 4) such that the leading five subset IDs indicate the training subsets 121 and the subsequent two subset IDs indicate the validating subsets 122.

The subset usage list 11b is not limited to the example illustrated in FIG. 5, and may include an item “training subset” indicating the subset IDs of the training subsets 121 and an item “validating subset” indicating the subset IDs of the validating subsets 122.

Returning to the explanation of FIG. 3, the subset arrangement policy determining unit 14 determines the subset arrangement policy 110 with reference to the subset usage list 11b and stores the policy 110 in the high-speed memory unit 11. The subset arrangement policy 110 may include the initial arrangement ID list 11c, the split execution order list 11d, the swapping ID list 11e, and the swapping timing 11f, as illustrated in FIG. 3.

### Pre-Processing

Upon receipt of an instruction of the determining process of the subset arrangement policy 110 from the cross validation processing unit 13, the subset arrangement policy determining unit 14 initializes the subset arrangement policy 110. For example, the subset arrangement policy determining unit 14 empties (i.e., sets Null in) the initial arrangement ID list 11c, the split execution order list 11d, and the swapping ID list 11e and sets “−1” in the swapping timing 11f.

Further, the subset arrangement policy determining unit 14 calculates the subset number in the high-speed memory unit, which is the number (predetermined number) of subsets 120 that can be stored in the high-speed memory unit 11. For example, the subset arrangement policy determining unit 14 may obtain, as the subset number in the high-speed memory unit, a value (truncating after the decimal point; quotient) obtained by dividing the free capacity (size of a free storing region) of the high-speed memory unit 11 by data size of a single subset 120. By calculating the subset number in the high-speed memory unit, an appropriate number in subsets 120 to be arranged in the high-speed memory unit 11 can be specified. The one embodiment assumes that the subset number of the high-speed memory unit is 4.

### Determining Process of the Initial Arrangement ID List 11c and the Split Execution Order List 11d

The subset arrangement policy determining unit 14 obtains, for all the execution orders of the splits of the subset usage list 11b, the total number of consecutive usage count of the subsets 120 of the subset number in the high-speed memory unit, and the subset IDs of the subsets 120.

All the execution orders (split execution orders) of the splits are not only execution order illustrated in FIG. 4 but also all the execution orders that multiple splits can take, and is exemplified by the execution orders as the factorial of the number of splits (if the number of splits is four, 4!). The split execution order is an example of candidate patterns of the execution order of multiple splits (steps).

The consecutive usage count is the number of times the same subset 120 is consecutively used over multiple splits from the first split of the execution order. The consecutive usage count is an example of the number of times that each individual subset 120 is consecutively used over splits in the split execution order for each split execution order (candidate pattern).

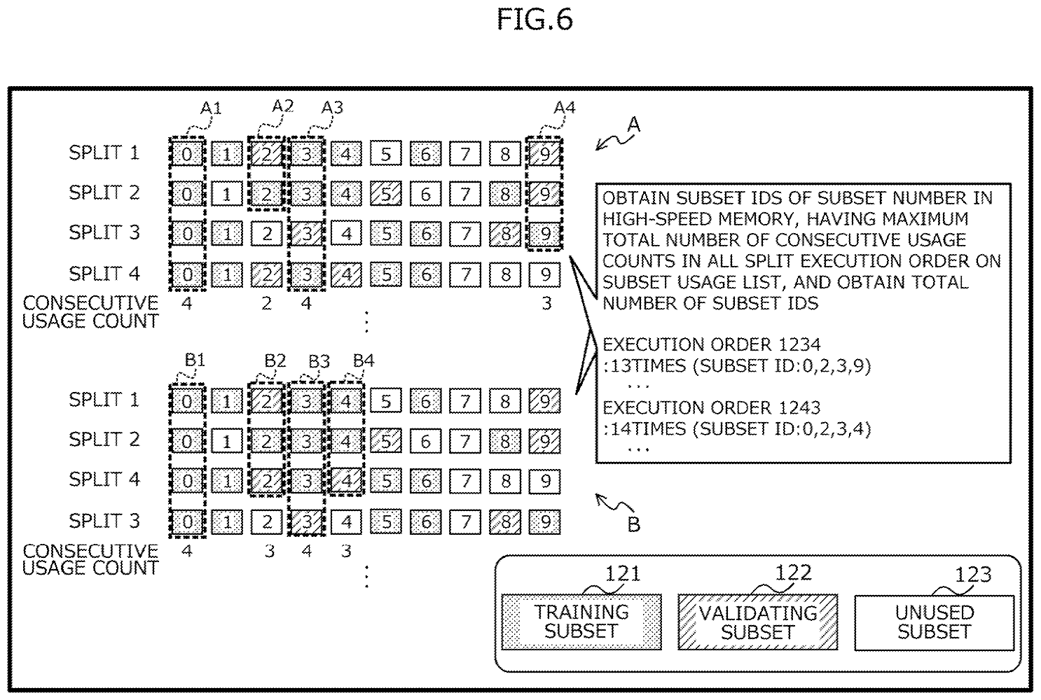

FIG. 6 is a diagram illustrating an example of a consecutive usage counts and obtaining of subset IDs for each execution order. In FIG. 6, the reference sign A denotes an example of obtaining of the total number of consecutive usage counts in the order of split 1, split 2, split 3, and split 4 (hereinafter, expressed by “execution order 1234” by arranging the split IDs in the execution order). The reference sign B indicates an example of obtaining of the total number of consecutive usage counts of execution order 1243.

The subset arrangement policy determining unit 14 obtains the consecutive usage count for each of subset IDs: 0 to 9.

In the case of reference sign A in FIG. 6, the subset arrangement policy determining unit 14 obtains a consecutive usage count “four” because the subset ID: 0 is used four consecutive times from the split 1 that is the top of the execution order 1234 (see reference sign A1). Since the subset ID: 1 is used once in the split 1 that is the top of the execution order 1234 and is not used in the split 2, the subset arrangement policy determining unit 14 obtains a consecutive usage count “one”. Similarly, the subset arrangement policy determining unit 14 obtains a consecutive usage count “two” for the subset ID: 2 (see reference numeral A2), a consecutive usage count “four” for the subset ID: 3 (see reference numeral A3), and a consecutive usage count “three” for the subset ID: 9 (see reference numeral A4). The subset arrangement policy determining unit 14 obtains a consecutive usage count “two” for the subset ID: 4, a consecutive usage count “one” for the subset ID: 6, and a consecutive usage count “zero” or “-” (which means none) for the subset IDs: 5, 7, and 8.

As described above, the subset arrangement policy determining unit 14 obtains, with respect to the reference sign A, the four subset IDs 0, 2, 3, and 9 from the top (which corresponds to the subset number in the high-speed memory unit) that have the four largest consecutive usage counts and the total number 13 of the consecutive usage counts of these four subset IDs.

Similarly, the subset arrangement policy determining unit 14 obtains, with respect to the reference sign B, the four subset IDs 0, 2, 3 from the top, and 4 (see the reference signs B1 to B4) that have the four largest consecutive usage counts and the total number 14 of the consecutive usage counts for these four subset IDs.

When the split number is four, the subset arrangement policy determining unit 14 obtains subset IDs the same as the subset number in the high-speed memory unit and the total number of the consecutive usage counts of the obtained subset IDs for each of the 4!=24 execution orders.

Incidentally, if multiple subsets 120 having the same consecutive usage count are present in specifying the subsets 120 of the subset number in the high-speed memory unit having the largest consecutive usage counts from the top, the subset arrangement policy determining unit 14 may select the subsets 120 according to a predetermined priority order. As an example, the subset arrangement policy determining unit 14 may preferentially select a subset 120 having a younger (smaller) subset ID.

After obtaining the subset IDs and the total number of consecutive usage counts for all the execution order, the subset arrangement policy determining unit 14 specifies the execution order having the largest total number of consecutive usage number among the multiple execution orders.

Then, the subset arrangement policy determining unit 14 registers the specified execution order into the split execution order list 11d, and also registers a given number of subset IDs having the largest consecutive usage counts from the top over the splits in the specified execution order into the initial arrangement ID list 11c.

As described above, the subset arrangement policy determining unit 14 determines an execution order of the candidate patterns having the largest total number of consecutive usage counts to be the execution order of the multiple splits of the cross validation process.

The initial arrangement ID list 11c is information indicating subsets 120 to be arranged (initially arranged) in the high-speed memory unit 11 prior to the starting of the cross validation process, and is information to specify the subset 11a illustrated in FIG. 3.

The split execution order list 11d indicates the execution order of the cross validation process. Specifically, the split execution order list 11d is an execution order regarded as a replacement (i.e., after updating) of the execution order (the execution order 1234 in the example of FIG. 4) temporarily set by the cross validation processing unit 13.

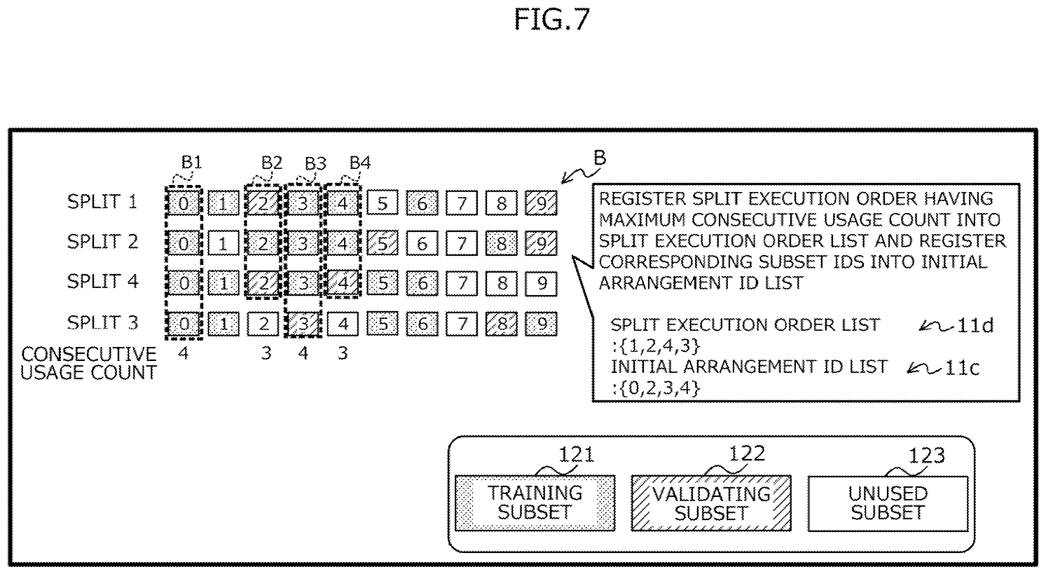

FIG. 7 is a diagram illustrating an example of an initial arrangement ID 11c list and a split execution order list 11d. FIG. 7 illustrates a case where the total number of consecutive usage counts of the execution order 1243 is the largest among the multiple execution orders.

As illustrated in FIG. 7, the subset arrangement policy determining unit 14 registers the split IDs {1, 2, 4 3} of the specified execution order 1243 into the split execution order list 11d. In addition, subset arrangement policy determining unit 14 sets subset IDs {0, 2, 3, 4} of the predetermined number of subset 120 acquired in the executing order 1243 in initial arrangement ID list 11c.

As described above, the subset arrangement policy determining unit 14 can determine an execution order of a cross validation process in which the number of times that particular subsets 120 are each consecutively used becomes the largest among multiple iterations of the training and the accuracy evaluation in the cross validation, and the particular subsets 120 themselves (see FIG. 6). Arranging the particular subsets 120 each having a large access number in the high-speed memory unit 11 can increase the access number to the high-speed memory unit 11.

In other words, the subset arrangement policy determining unit 14 determines, as a particular subsets 120, subsets 11a (see FIG. 3) to be initially arranged in the high-speed memory unit 11.

The subsets 120 not arranged in the high-speed memory unit 11 among the multiple subsets 120 are the subsets 12a in the low-speed memory unit 12 illustrated in FIG. 3. The subsets 12a are subsets each having a relatively small number of times of usage in multiple iterations of the training and the accuracy evaluation in the cross validation.

### Determining Process of the Swapping ID List 11e and the Swapping Timing 11f

The initial arrangement ID list 11c obtained in the above-described determining process is calculated on the basis of the consecutive usage count of a subset continuously used from the first split 1 of the executing order. For the above, the possibility that a subset 120 in the initial arrangement ID list 11c is accessed to serve as a training subset 121 or the validating subset 122 lowers when the cross validation process proceeds to the second half splits (e.g., the split 3 in the example of FIG. 7).

As a solution to the above, the subset arrangement policy determining unit 14 then determines the swapping ID list 11e and the swapping timing 11f.

The swapping timing 11f is information indicating a timing at which a subset 11a that is unlikely to be accessed in the second-half splits in the execution order are swapped with a subset 12a that is likely to be accessed in the second-half splits in the execution order. In other words, the swapping timing 11f is information indicating a timing at which one or more subsets 120 are exchanged (hierarchical control) between the high-speed memory unit 11 and the low-speed memory unit 12.

The swapping ID list 11e is information to select a subset 120 to be swapped between the high-speed memory unit 11 and the low-speed memory unit 12 at the swapping timing 11f.

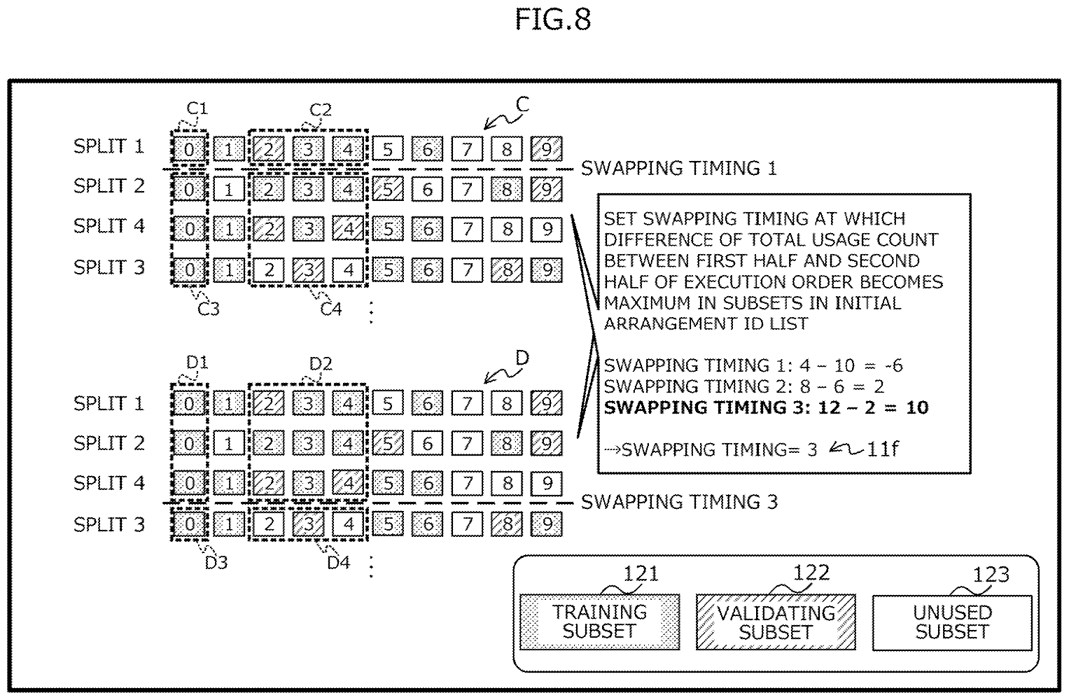

FIG. 8 is a diagram illustrating an example of a determining process of a swapping timing 11f. The subset arrangement policy determining unit 14 determines multiple swapping timing candidates for setting the swapping timing 11f in the determined execution order 1243. The multiple swapping timing candidates are an example of multiple timings between steps in the execution order of the multiple splits. In FIG. 8, the reference sign C indicates a swapping timing candidate (denoted as “swapping timing 1”) set between the split 1 and the split 2. The reference sign D indicates a swapping timing candidate (denoted as “swapping timing 3”) set between the split 4 and the split 3.

The subset arrangement policy determining unit 14 calculates, for each swapping timing candidate, a difference between the total usage count of one or more steps before the swapping timing candidate (i.e., the first half of the execution order 1243) and the total usage count of one or more steps after the swapping timing candidate (i.e., the second half of the execution order 1243).

For example, in the case of the reference sign C, the subset arrangement policy determining unit 14 obtains a total usage count 4 (see C1 and C2) that the subset IDs: 0, 2, 3, and 4 are used as the training subsets 121 or the validating subsets 122 before the swapping timing 1 (first half). In addition, the subset arrangement policy determining unit 14 obtains a total usage count 10 (see C3 and C4) of the subset IDs: 0, 2, 3, and 4 after the swapping timing 1 (second half). Then, the subset arrangement policy determining unit 14 calculates the difference “−6” by subtracting the total usage count 10 of the second half from the total usage count 4 of the first half.

Furthermore, for example, in the case of the reference sign D, the subset arrangement policy determining unit 14 obtains a total usage count 12 (see D1 and D2) of the subset IDs: 0, 2, 3, and 4 before the swapping timing 3 (first half). In addition, the subset arrangement policy determining unit 14 obtains a total usage count 2 (see D3 and D4) of the subset IDs: 0, 2, 3, and 4 after the swapping timing 3 (second half). Then, the subset arrangement policy determining unit 14 calculates the difference “10” by subtracting the total usage count 2 of the second half from the total usage count 12 of the first half.

As illustrated in FIG. 8, when the swapping timing 2 between the split 2 and the split 4 is applied, the subset arrangement policy determining unit 14 calculates the difference “2” by subtracting the total usage count 6 of the second half from the total usage count 8 of the first half.

Then, the subset arrangement policy determining unit 14 sets “3” indicating the swapping timing 3 having the largest calculated difference among the multiple swapping timing candidates into the swapping timing 11f.

As described above, the subset arrangement policy determining unit 14 specifies the swapping timing 11f that is a boundary between the split 4 having a large access number to the subsets 11a in the high-speed memory unit 11 and the split 3 having a small access number to the subsets 11a in the high-speed memory unit 11. This makes it possible to concentrate accesses to the subsets 11a before the swapping timing 11f and swap the subsets 120 to be arranged in the high-speed memory unit 11 at the swapping timing 11f when the access count to the subsets 11a reduces. In other words, it is possible to suppress a decrease in the access number to the high-speed memory unit 11 after the swapping timing 11f (which means to reduce the access number to the low-speed memory unit 12).

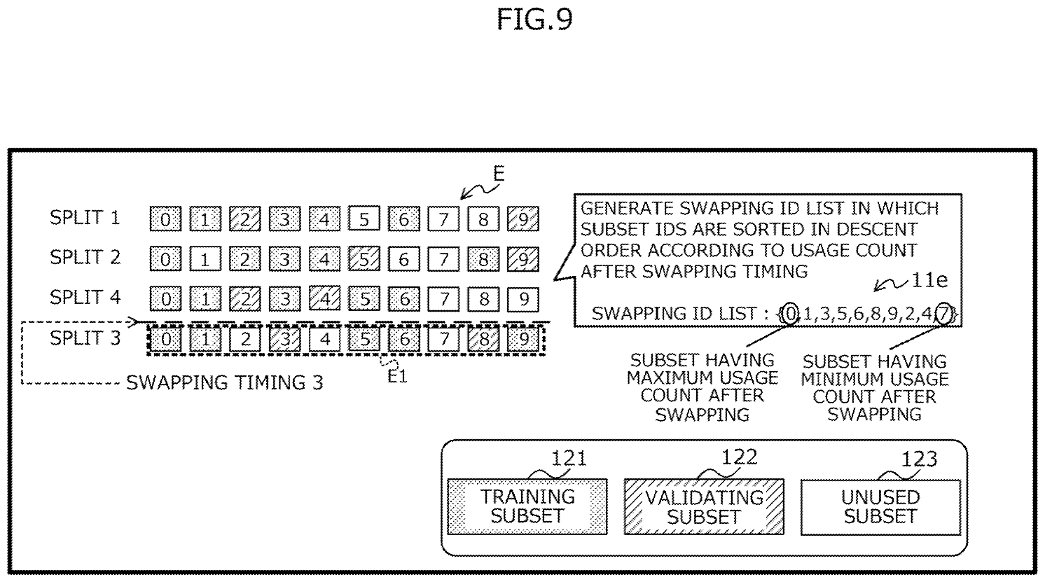

FIG. 9 is a diagram illustrating an example of obtaining a swapping ID list 11e. The subset arrangement policy determining unit 14 generates the swapping ID list 11e in which subset IDs of the multiple subsets 120 are sorted in the descending order of the usage count after the swapping timing 11f (see the reference sign E1).

The swapping ID list 11e is an example of second information in which identification information of each subsets 120 are sorted in an order according to a usage count representing a number of times each of the multiple subsets 120 is used in one or more steps after the swapping timing 11f.

If multiple subsets 120 have the same usage count, the subset arrangement policy determining unit 14 may sort the subsets 120 according to a predetermined priority order. As an example, the subset arrangement policy determining unit 14 may preferentially arrange a subset 120 having a younger (smaller) subset ID closer to the top of the list.

In the example of FIG. 9, since the usage count of the subsets of the subset IDs 0, 1, 3, 5, 6, 8, and 9 is one (the largest usage count after the swapping timing 11f), the subset arrangement policy determining unit 14 sets these subsets sequentially from the top of the swapping ID list 11e. In addition, since the usage count of the subsets of the subset IDs 2, 4, and 7 is zero, the subset arrangement policy determining unit 14 sets these subset in the swapping ID list 11e subsequently to the subset ID 9.

In the swapping ID list 11e, subset IDs may be set in the order of the usage counts x, x-1, . . . , 1, and 0 (descending order) in accordance with the number x of splits (iterations) after the swapping timing 11f. FIG. 9 illustrates the case where x=1. For example, when x=2 (when the swapping timing 11f is set between the spit 2 and the split 4), the subset IDs of {0, 1, 3, 5, 6, 2, 4, 8, 9, 7} are set in the swapping ID list 11e.

As described above, the subset arrangement policy determining unit 14 sets the swapping ID list 11e such that the subset ID having the largest usage count after the swapping timing 11f is positioned on the top of the swapping ID list 11e and the subset ID having the smallest usage count after the swapping timing 11f is positioned on the bottom of the swapping ID list 11e.

### Notifying Process of the Subset Arrangement Policy 110 to the Subset Arranging Unit 15

After determining the subset arrangement policy 110 in the above-described process, the subset arrangement policy determining unit 14 notifies the subset arranging unit 15 of the determined subset arrangement policy 110.

In the examples described with reference to FIGS. 5-9, the subset arrangement policy 110 includes the following information.

Initial arrangement ID list 11c: {0, 2, 3, 4}

split execution order list 11d: {1, 2, 4, 3}

Swapping ID list 11e: {0, 1, 3, 5, 6, 8, 9, 2, 4, 7}

Swapping timing 11f: 3

The subset arranging unit 15 performs an arranging process of the subset 11a into the high-speed memory unit 11 based on the subset arrangement policy 110.

Here, as described above, in hierarchical memory system 20, the OS executed by the HW or processor 10a carries out the data arrangement control between the high-speed memory 21 and the low-speed memory 22, for example, cache control via the LRU algorithm.

When the cache control via the LRU algorithm is performed, even if the subsets 11a are arranged in the high-speed memory unit 11 on the basis of the initial arrangement ID list 11c, the subset 11a has a possibility of being evicted to the low-speed memory unit 12 before the swapping timing 11f.

As a solution to the above, when receiving the subset arrangement policy 110 from the subset arrangement policy determining unit 14, the subset arranging unit 15 may disable the cache control via the LRU algorithm. As an example, when the high-speed memory 21 is a DRAM and the low-speed memory 22 is an SSD, the subset arranging unit 15 may disable the swapping function of the OS. Alternatively, if the high-speed memory 21 is a DRAM and the low-speed memory 22 is an NVDIMM, the subset arranging unit 15 may set the operating mode of the NVDIMM to one that utilizes the DRAM and the NVDIMM (PM) as separate memories.

In this way, treating the high-speed memory 21 and the low-speed memory 22 as separate memory (or a memory and a storage device), the subset arranging unit 15 executes the subset arranging process to the separate memories based on the access pattern to the subsets 120.

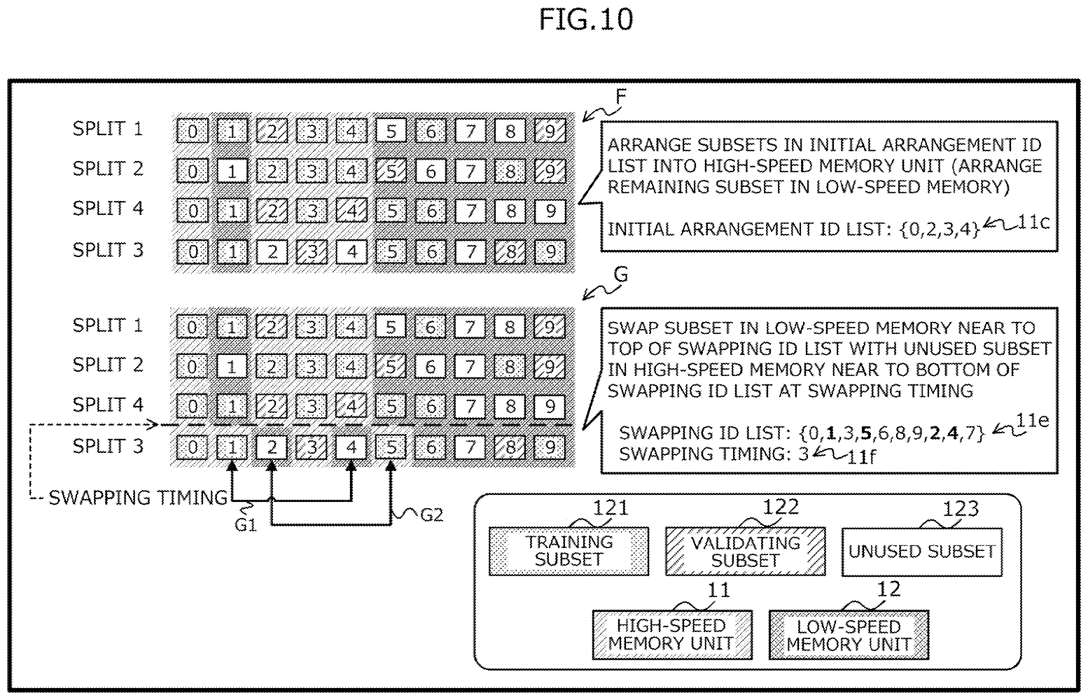

FIG. 10 is a diagram illustrating an example of a subset arranging process. In FIG. 10, the reference sign F denotes an example of an arranging process at an initial arranging timing of the subsets 120, and the reference sign G denotes an example of an arranging process at the swapping timing 11f of the subsets 120. In FIG. 10, the background of the subset 120 arranged in the high-speed memory unit 11 is illustrated in thin hatched line, and the background of the subsets 120 arranged in the low-speed memory unit 12 is illustrated in dense shading.

### Subset Arranging Process at Initial Arranging Timing

As indicated by the reference sign F, the subset arranging unit 15 arranges (migrations) the subsets 120 (subset IDs: 0, 2, 3, 4) in the initial arrangement ID list 11c from the low-speed memory unit 12 to the high-speed memory unit 11 as the subset 11a (see FIG. 3). The subset arranging unit 15 may remove the subsets 11a from the subsets 120 in the low-speed memory unit 12.

The subsets 120 (subset ID: 1, 5, 6, 7, 8, and 9) not included in the initial arrangement ID list 11c are arranged in the low-speed memory unit 12 as the subsets 12a (see FIG. 3). In FIG. 3, the subsets 120 are illustrated apart from the subsets 12a for convenience, but the subsets 12a may mean subsets 120 among the subsets 120 not being arranged in the high-speed memory unit 11. That is, the subsets 12a need not be generated from the multiple subsets 120 by duplication or the like.

After the initial arrangement process of the subsets 120 is completed, the subset arranging unit 15 may instruct the cross validation processing unit 13 to execute the cross validation process until the swapping timing 11f.

As described above, the subset arranging unit 15 arranges, into the high-speed memory unit 11, a given number of subsets 120 having the largest consecutive usage counts from the top over multiple steps in the execution order determined by the subset arrangement policy determining unit 14.

### Subset Arranging Process at the Swapping Timing 11f

Upon detecting that the swapping timing 11f comes, the subset arranging unit 15 swaps the arrangement of the subsets 12a in the low-speed memory unit 12 with the arrangement of subsets 11a in the high-speed memory unit 11 with reference to the swapping ID list 11e, as indicated by the reference sign G.

For example, the subset arranging unit 15 swaps the subsets 12a being listed close to the top of the swapping ID list 11e and being stored in the low-speed memory unit 12 with the subsets 11a being listed close to the bottom of the swapping ID list 11e and being stored in the high-speed memory unit 11.

A unused subset 11a being listed close to the bottom of the swapping ID list 11e and being stored in the high-speed memory unit 11 is an example of a first subset that is not used in one or more steps after the swapping timing 11f among the given number of subsets 11a stored in the high-speed memory 11. A subset 12a being listed close to the top of the swapping ID list 11e and being stored in the low-speed memory 12 is an example of a second subset that is used in one or more steps after the swapping timing 11f among the subsets 12a stored in the low-speed memory 12.

In the example of FIG. 10, the subset arranging unit 15 swaps the arrangement of the subset ID: 1 being listed close to the top of the swapping ID list 11e and being stored in the low-speed memory unit 12 with the arrangement of the subset ID: 4 being listed close to the bottom of the swapping ID list 11e and being stored in the high-speed memory unit 11 (see reference sign G1).

Furthermore, the subset arranging unit 15 swaps the arrangement of the subset ID: 5 being listed close to the top of the swapping ID list 11e and being stored in the low-speed memory unit 12 with the arrangement of the subset ID: 2 being listed close to the bottom of the swapping ID list 11e and being stored in the high-speed memory unit 11 (see reference sign G2).

The swapping of the arrangements may mean that the layers (the high-speed memory unit 11 and the low-speed memory unit 12) in which the two subsets 120 are stored are replaced with each other. For example, the subset arranging unit 15 may store a subset 12a stored in the low-speed memory unit 12 into the storing position (address) for the subset 11a in the high-speed memory unit 11, and may alternatively store the subset 12a stored in the low-speed memory unit 12 into an empty region different from the above storing region of the high-speed memory unit 11.

The subset arranging unit 15 may search for a subset ID matching the condition for swapping the arrangement from the top or the bottom of the swapping ID list 11e, for example. The subset arranging unit 15 may remove, from the swapping ID list 11e, a subset ID that matches the condition and that completes the swapping and a subset ID not matching the condition.

Then, in the search of the swapping ID list 11e, the subset arranging unit 15 may terminate the search for a subset ID when the usage count of the subset on the bottom of the swapping ID list 11e after the swapping timing 11f comes not to be zero. The subset 120 on the bottom of the swapping ID list 11e, if being stored in the high-speed memory unit 11, is a candidate for being migrated (evicted) to the low-speed memory unit 12. However, the usage count of the subset on the bottom of the swapping ID list 11e after the swapping timing 11f not being zero (not being an unused subset 120) means that the bottom subset 120 is accessed in the high-speed memory unit 11, i.e., does not have to be migrated to the low-speed memory unit 12.

Upon completion of the swapping process of the arrangements of subsets 120 at the swapping timing 11f, the subset arranging unit 15 may instruct the cross validation processing unit 13 to execute the cross validation process after the swapping timing 11f.

### (B) Example of Operation

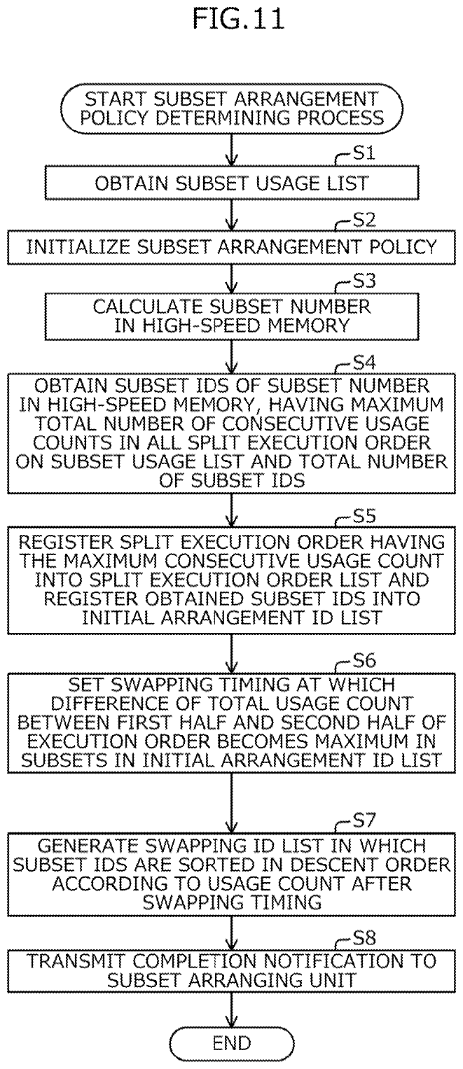

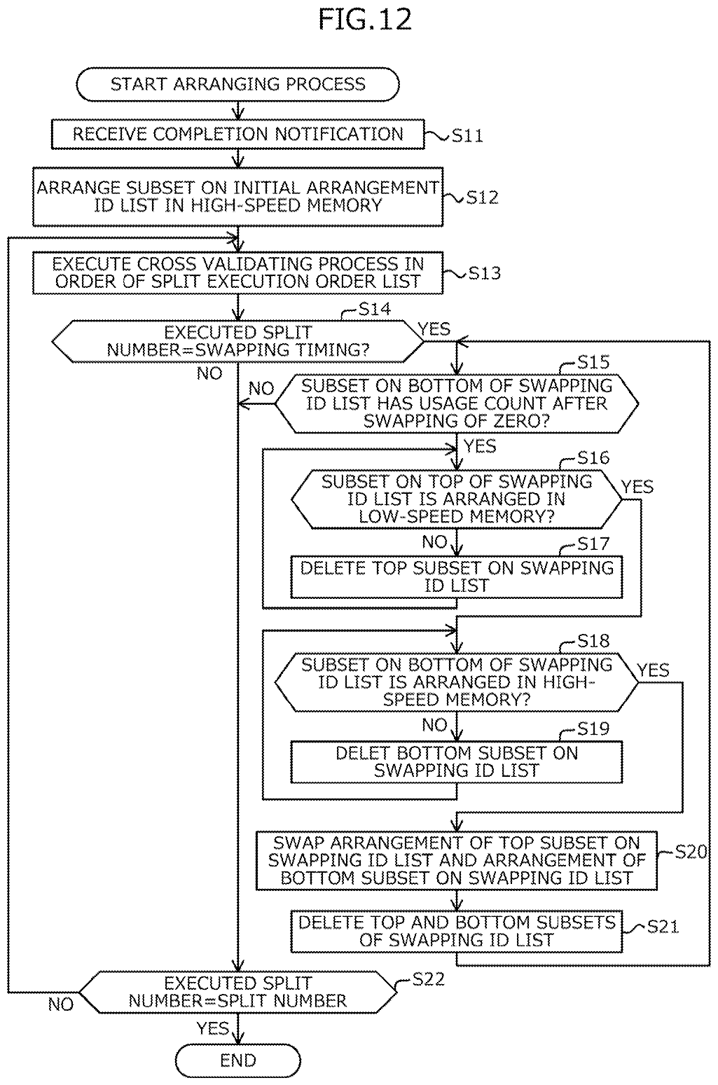

Next, description will now be made in relation to examples of operation of the above cross validation apparatus 1 according to the one embodiment with reference to FIGS. 11 and 12.

### (B-1) Determining Process of Subset Arrangement Policy

FIG. 11 is a flow diagram illustrating an example of operation of a determining process of a subset arrangement policy 110 performed by the cross validation apparatus 1 according to one embodiment. It is assumed that the cross validation processing unit 13 has divided the data set into multiple subsets 120 and generated a subset usage list 11b in response to a processing request for cross validation.

As illustrated in FIG. 11, the subset arrangement policy determining unit 14 obtains the subset usage list 11b from the cross validation processing unit 13 (Step S1).

The subset arrangement policy determining unit 14 initializes the subset arrangement policy 110 (Step S2). For example, the subset arrangement policy determining unit 14 empties the initial arrangement ID list 11c, the split execution order list 11d, and the swapping ID list 11e, and sets “−1” in the swapping timing 11f.

The subset arrangement policy determining unit 14 calculates the subset number in the high-speed memory unit by dividing (truncating after the decimal point) the free capacity of the high-speed memory unit 11 (the size of the free storing region) by the size of subset 120 per unit (Step S3).

The subset arrangement policy determining unit 14 obtains the subsets 120 being the same number as the subset number in the high-speed memory unit and having the largest total number of the consecutive usage counts and the total number of the consecutive usage count of the subsets 120 for each split execution order in the subset usage list 11b (Step S4).

The subset arrangement policy determining unit 14 registers the split execution order having the largest total number of the consecutive usage counts into the split execution order list 11d, and registers subset IDs obtained for the registered split execution order into the initial arrangement ID list 11c (Step S5).

The subset arrangement policy determining unit 14 sets the swapping timing 11f at which the difference of total usage count of the subsets 120 included in the initial arrangement ID list 11c between first half and second half from the multiple swapping timing candidates (Step S6).

The subset arrangement policy determining unit 14 generates the swapping ID list 11e in which subset IDs are sorted in the descent order according to usage count at the swapping timing 11f (Step S7).

The subset arrangement policy determining unit 14 transmits the completion notification of the determining process of the subset arrangement policy 110 to the subset arranging unit 15 (Step S8), and the determining process of the subset arrangement policy 110 ends.

### (B-2) Arranging Process of Subset

FIG. 12 is a flow diagram illustrating an example of an arranging process of a subset 120 performed by the cross validation apparatus according 1 to one embodiment.

As illustrated in FIG. 12, the subset arranging unit 15 receives completion notification from the subset arrangement policy determining unit 14 (Step S11). The subset arranging unit 15 disables the cache control by the LRU algorithm. The timing of disabling the cache control may be earlier than Step S11.

The subset arranging unit 15 arranges, as subset 11a, the subsets 120 in the initial arrangement ID list 11c from the low-speed memory unit 12 to the high-speed memory unit 11 (Step S12).

The subset arranging unit 15 instructs the cross validation processing unit 13 to execute the cross validation process in the order of split execution order list 11d. The cross validation processing unit 13 executes the cross validation process with reference to the split execution order list 11d (Step S13).

When the execution of the cross validation process is completed for one split, the subset arranging unit 15 determines whether or not the number of splits that have been executed matches the swapping timing 11f (three in the example of FIG. 10) (Step S14).

If the number of splits that have been executed does not match the swapping timing 11f (NO in Step S14), the process proceeds to Step S22.

When the number of splits that have been executed matches the swapping timing 11f (YES in Step S14), the subset arranging unit 15 determines whether or not the usage count of a subset 120 on the bottom of the swapping ID list 11e after the swapping timing 11f is zero (Step S15).

If the usage count is zero (YES in Step S15), the subset arranging unit 15 determines whether or not the subset 120 on the top of the swapping ID list 11e is arranged in the low-speed memory unit 12 (Step S16).

If the top subset 120 is not arranged in the low-speed memory unit 12 (NO in Step S16), the subset arranging unit 15 deletes the top subset of the swapping ID list 11e (Step S17), and the process moves to Step S16.

If the top subset 120 is arranged in the low-speed memory unit 12 (YES in Step S16), the subset arranging unit 15 determines whether or not the subset 120 on the bottom of the swapping ID list 11e is arranged in the high-speed memory unit 11 (Step S18). The subset 120 on the bottom of the swapping ID list 11e is a subset determined to have a usage count after the swapping timing of zero in Step S15.

If the subset 120 on the bottom of the swapping ID list 11e is not arranged in the high-speed memory unit 11 (NO in Step S18), the subset arranging unit 15 deletes the bottom subset of the swapping ID list 11e (Step S19), and the process proceeds to Step S18.

If the subset 120 on the bottom of the swapping ID list 11e is arranged in the high-speed memory unit 11 (YES in Step S18), the subset arranging unit 15 swaps the arrangements of subsets 120 (Step S20). For example, the subset arranging unit 15 swaps the arrangement of the subset 120 being listed on the top of the swapping ID list 11e and being stored in the low-speed memory unit 12 with the subset 120 (unused subset 123) being listed on the bottom of the swapping ID list 11e and being stored in the high-speed memory unit 11.

Then, the subset arranging unit 15 deletes the top subset and the bottom subset of the swapping ID list 11e (Step S21), and the process moves to Step S15.

In Step S15, if the usage count of the subset 120 on the bottom of the swapping ID list 11e after the swapping timing 11f is not zero (NO in Step S15), the process proceeds to Step S22.

In Step S22, the subset arranging unit 15 determines whether or not the executed split number matches the total number of splits (four in FIG. 10).

If the executed split number does not match the total number of splits (NO in Step S22), the process moves to Step S13 and the subset arranging unit 15 causes the cross validation processing unit 13 to execute the cross validation process on the subsequent split of the split execution order list 11d.

If the executed split number matches the total number of splits (YES in Step S22), the arranging process of the subsets 120 is completed.

### (C) Effect of the One Embodiment

As described above, the cross validation apparatus 1 according to the embodiment calculates, based on the subset usage list 11b, the consecutive usage count that each subset 120 is consecutively used over steps in each of candidate pattern of multiple execution order of the multiple steps. In addition, the cross validation apparatus 1 determines, as the execution order of the multiple steps of the cross validation process, an execution order of a candidate pattern having the largest total number of the consecutive usage counts. Then, the cross validation apparatus 1 arranges, into the high-speed memory unit 11, a given number of subsets having the largest consecutive usage numbers from the top over steps in the determined execution order.

Consequently, the cross validation apparatus 1 can initially arrange a given number of subsets having the largest access number (usage counts) from the top into the high-speed memory unit 11. In addition, the cross validation apparatus 1 can determine the execution order of the multiple steps of the cross validation process such that the total of the access numbers of the given number of subsets 120 comes to be the maximum. This makes it possible to increase the access number to the high-speed memory unit 11 and therefore achieve a rapid cross validation process.

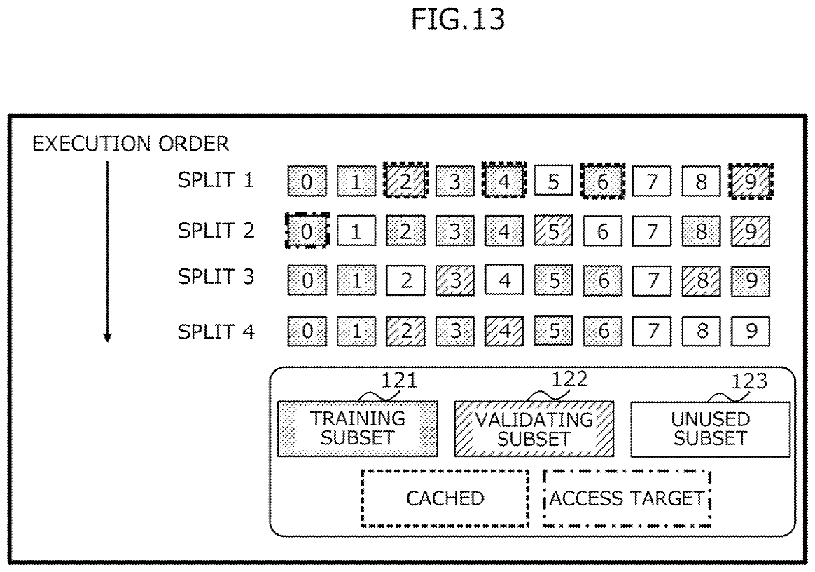

FIG. 13 is a diagram illustrating an example of a cross validating process according to a comparative example. FIG. 13 illustrates a case where the subsets 120 are arranged in the high-speed memory unit 11 and the low-speed memory unit 12 by cache control using the LRU algorithm, not adopting the scheme according to the one embodiment.

In the example of FIG. 13, the subsets 120 are used in the order of the subsets ID: 0, 1, 3, 4, 6, 2, and 9 in the split 1.

When the subset number in the high-speed memory unit is four, the subsets 120 arranged (cached) in the high-speed memory unit 11 at the start of the cross validation process of the split 2 are subset IDs: 4, 6, 2, and 9 in the cached order (LRU order).

In the cross validation process of the split 2, an access to a subset ID: 0 is an access to the low-speed memory unit 12. After that, the subsets 120 stored in the high-speed memory unit 11 by the cache control are subsets ID: 6, 2, 9, and 0.

An access to subset ID: 2 is an access to the high-speed memory unit 11, and the LRU order is updated to the subset IDs: 6, 9, 0, and 2 in cache control.

An access to the subset ID: 3 is an access to the low-speed memory unit 12. Thereafter, the subsets 120 stored in high-speed memory unit 11 become subset IDs: 9, 0, 2, and 3 by the cache control.

An access to a subset ID: 4 is an access to the low-speed memory unit 12. After that, the subsets 120 stored in the high-speed memory unit 11 by the cache control are subsets ID: 0, 2, 3, and 4.

As the above, the cache control by the LRU algorithm evicts a subset 120 cached in the high-speed memory unit 11 to the low-speed memory unit 12 prior to being accessed again in the cross validation process in a subsequent split. Accordingly, the frequency of accessing the low-speed memory unit 12 is increased, and the performance of the computer executing the cross validation process is restricted.

In contrast, as illustrated in FIG. 10, the cross validation apparatus 1 according to the one embodiment fixedly arranges the given number of subsets 11a having the largest access counts from the initial arrangement timing to the swapping timing 11f in the high-speed memory unit 11. In addition, after the swapping timing 11f, in expectation of a change (decrease) in an access counts to the subsets 11a initially arranged in the high-speed memory unit 11, the subsets 12a having the largest access count after the swapping timing 11f are rearranged in the high-speed memory unit 11.

Consequently, the cross validation apparatus 1 according to the embodiment can accomplish the cross validation process faster than the comparative example.

### (D) Miscellaneous

The technique according to the one embodiment described above can be implemented by changing or modifying as follows.

For example, the cross validation processing unit 13, the subset arrangement policy determining unit 14, and the subset arranging unit 15 illustrated in FIG. 3 may be merged or divided at any combination. The lists 11b to 11e stored in the high-speed memory unit 11 may be information merged or divided at any combination.

Further, although the swapping ID list 11e has been described as a list in which subsets 120 are sorted in the descending order of the total usage count, the present invention is not limited thereto and the swapping ID list 11e may be information in which subsets 120 is information in which subsets 120 are sorted in the ascending order of the total usage count. In this alternative, the swapping of the arrangements at the swapping timing 11f by the subset arranging unit 15 are executed in the above-described manner except for interchanging the “top” and the “bottom” in the above description.

In one aspect, the speed of a cross validation process of a machine learning model can be increased by an information processing apparatus including multiple memories that differ in access-speed from one another.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a cross validation program for causing a computer to execute a process comprising:
calculating, based on first information indicating an access pattern of a plurality of subsets in each of a plurality of steps of a cross validation process of a machine learning model and indicating two or more of the plurality of subsets used in each of the plurality of steps, a consecutive usage count that each of the plurality of subsets is consecutively used over steps among the plurality of steps in each of a plurality of candidate patterns for execution orders of the plurality of steps;
determining an execution order of the plurality of steps of the cross validation process from the execution orders of the plurality of candidate patterns, the determined execution order having a largest total of the consecutive usage counts of the plurality of subsets; and
arranging a given number of subsets having largest consecutive usage counts from a top over steps in the determined execution order into a second memory having an accessing speed higher than an accessing speed of a first memory, the first memory storing the plurality of subsets.

2. The non-transitory computer-readable recording medium according to claim 1, wherein the given number is a quotient obtained by dividing an empty region of the second memory by a data size of one of the plurality of subsets.

3. The non-transitory computer-readable recording medium according to claim 1, wherein
the determining comprises determining, as the determined execution order of the plurality of steps of the cross validation process, an execution order of a candidate pattern that has a largest total of the given number of the subsets having the largest consecutive usage counts from the top.

4. The non-transitory computer-readable recording medium according to claim 1, wherein the process further comprises:
specifying a timing between two of the plurality of steps in the execution order at which a difference is maximum, the difference being between a total of the consecutive usage counts of the given number of subsets in one or more of the plurality of steps before the timing and a total of the consecutive usage counts of the given number of subsets in one or more of the plurality of steps after the timing; and
swapping, at the specified timing, arrangement of a first subset not being used in one or more steps after the specified timing among the given number of subsets stored in the second memory with arrangement of a second subset used in one or more steps after the specified timing among subsets stored in the first memory.

5. The non-transitory computer-readable recording medium according to claim 4, wherein:
the process further comprises generating second information in which identification information of each of the plurality of subsets are sorted in an order according to a usage count representing a number of times each of the plurality of subsets is used in one or more of the plurality steps after the specified timing; and
the swapping comprises selecting the first subset and the second subset with reference to the second information.

6. A computer-implemented method for cross validation, the method comprising:
calculating, based on first information indicating an access pattern of a plurality of subsets in each of a plurality of steps of a cross validation process of a machine learning model and indicating two or more of the plurality of subsets used in each of the plurality of steps, a consecutive usage count that each of the plurality of subsets is consecutively used over steps among the plurality of steps in each of a plurality of candidate patterns for execution orders of the plurality of steps;
determining an execution order of the plurality of steps of the cross validation process from the execution orders of the plurality of candidate patterns, the determined execution order having a largest total of the consecutive usage counts of the plurality of subsets; and
arranging a given number of subsets having largest consecutive usage counts from a top over steps in the determined execution order into a second memory having an accessing speed higher than an accessing speed of a first memory, the first memory storing the plurality of subsets.

7. The computer-implemented method according to claim 6, wherein the given number is a quotient obtained by dividing an empty region of the second memory by a data size of one of the plurality of subsets.

8. The computer-implemented method according to claim 6, wherein
the determining comprises determining, as the determined execution order of the plurality of steps of the cross validation process, an execution order of a candidate pattern that has a largest total of the given number of the subsets having the largest consecutive usage counts from the top.

9. The computer-implemented method according to claim 6, wherein the method further comprises:
specifying a timing between two of the plurality of steps in the execution order at which a difference is maximum, the difference being between a total of the consecutive usage counts of the given number of subsets in one or more of the plurality of steps before the timing and a total of the consecutive usage counts of the given number of subsets in one or more of the plurality of steps after the timing; and
swapping, at the specified timing, arrangement of a first subset not being used in one or more steps after the specified timing among the given number of subsets stored in the second memory with arrangement of a second subset used in one or more steps after the specified timing among subsets stored in the first memory.

10. The computer-implemented method according to claim 9, wherein
the method further comprises generating second information in which identification information of each of the plurality of subsets are sorted in an order according to a usage count representing a number of times each of the plurality of subsets is used in one or more of the plurality steps after the specified timing; and
the swapping comprises selecting the first subset and the second subset with reference to the second information.

11. An information processing apparatus comprising:
a memory; and
a processor coupled to the memory, the processor being configured to
calculate, based on first information indicating an access pattern of a plurality of subsets in each of a plurality of steps of a cross validation process of a machine learning model and indicating two or more of the plurality of subsets used in each of the plurality of steps, a consecutive usage count that each of the plurality of subsets is consecutively used over steps among the plurality of steps in each of a plurality of candidate patterns for execution orders of the plurality of steps;
determine an execution order of the plurality of steps of the cross validation process from the execution orders of the plurality of candidate patterns, the determined execution order having a largest total of the consecutive usage counts of the plurality of subsets; and
arrange a given number of subsets having largest consecutive usage counts from a top over steps in the determined execution order into a second memory having an accessing speed higher than an accessing speed of a first memory, the first memory storing the plurality of subsets.

12. The information processing apparatus according to claim 11, wherein the given number is a quotient obtained by dividing an empty region of the second memory by a data size of one of the plurality of subsets.

13. The information processing apparatus according to claim 11, wherein the processor determines, as the determined execution order of the plurality of steps of the cross validation process, an execution order of a candidate pattern that has a largest total of the given number of the subsets having the largest consecutive usage counts from the top.

14. The information processing apparatus according to claim 11, wherein the processor is further configured to:
specify a timing between two of the plurality of steps in the execution order at which a difference is maximum, the difference being between a total of the consecutive usage counts of the given number of subsets in one or more of the plurality of steps before the timing and a total of the consecutive usage counts of the given number of subsets in one or more of the plurality of steps after the timing; and
swap, at the specified timing, arrangement of a first subset not being used in one or more steps after the specified timing among the given number of subsets stored in the second memory with arrangement of a second subset used in one or more steps after the specified timing among subsets stored in the first memory.

15. The information processing apparatus according to claim 14, wherein the processor is further configured to:
generate second information in which identification information of each of the plurality of subsets are sorted in an order according to a usage count representing a number of times each of the plurality of subsets is used in one or more of the plurality steps after the specified timing; and
select the first subset and the second subset with reference to the second information for the swap.
